(19) United States
(12) Patent Application Publication
(10) Pub. No.: US 2020/0345136 A1
(43) Pub. Date: Nov. 5, 2020

(54) COMBINATION FRONT AND REAR DOOR PROPANE CYLINDER/CANISTER STORAGE CABINET

(71) Applicant: Christopher DeCarlo, Fairfax, VA (US)

(72) Inventor: Christopher DeCarlo, Fairfax, VA (US)

(21) Appl. No.: 16/403,337

(22) Filed: May 3, 2019

(51) Int. Cl. A47B 81/00; E06B 3/76; B60P 3/055; B66F 9/06

(52) U.S. Cl. CPC A47B 81/007; B66F 9/06; B60P 3/055; E06B 3/76

(57) ABSTRACT

A system, and method of using a system can include at least one storage cabinet, which can include: a plurality of sides; at least one front door, coupled to at least one of said plurality of the sides; at least one back door, coupled to at least one of the plurality of the sides; a plurality of forklift pockets coupled to the at least one storage cabinet; and at least one shelf coupled to the at least one storage cabinet.

### BACKGROUND OF THE DISCLOSURE

### Field of the Disclosure

The present invention relates generally to a cabinet for receiving and storing a plurality of flammable, combustible, or other hazardous material canisters.

### Related Art

Pressurized containers, such as liquid propane tanks, cylinders, or canisters, require safe storage. Conventional safe storage of propane tanks involves storing the propane tanks outdoors and away from heat sources. Major retail sellers of filled propane tanks typically store propane tanks in a cabinet, often referred to as a cage, located outside of a building. In addition to storing the propane tanks outside, conventional cabinets include a front door usually only secured with a conventional lock, such as a combination lock or padlock, to prevent unauthorized access. The conventional lock is placed at a handle location to secure against unauthorized opening of the cage front door. Conventionally, a lock is located at a single location, such as by a handle or a center location of the cabinet, leaving corners of the cabinet vulnerable to tampering to obtain access to the interior of the cage. Conventional cabinets can remain vulnerable to tampering and unauthorized access by vandals.

Storage cabinets, including, e.g., but not limited to, safety cabinets, can be used for storing flammable and/or explosive materials, etc. Such cabinets and safety cabinets can allow for onsite storage of flammable materials such as, e.g., but not limited to, liquid propane (LP) gas canisters or cylinders, etc. A storage cabinet can be used to secure cabinet contents to avoid theft, or unauthorized access to the contents. Some safety cabinets can insulate flammable material stored within the cabinet from direct effects of an external fire, to prevent the flammable material from adding to the deleterious effect of the original fire, such cabinets often include double solid wall construction. Because of the nature of the materials stored in a safety cabinet and risks those materials pose to personnel in the vicinity of the safety cabinet, it is desirable to alert those in the area of these risks. Often, either according to occupational safety law or to a corporate internal standard operating procedure or policy, the safety cabinet can be equipped with a locking mechanism, which can provide an added safety feature by preventing inadvertent, improper usage of the flammable material and by allowing access to the flammable material to be restricted only to authorized personnel. Conventional storage cabinets, including safety cabinets can be difficult to transport, for example, from one location to another within a facility.

Therefore, what is needed in an improved cabinet that overcomes shortcomings of conventional solutions.

### SUMMARY OF THE DISCLOSURE

Various example embodiments or exemplary embodiments of the present invention are set forth below in the accompanying disclosure. The present disclosure incorporates a number of known technologies into a useful, novel and nonobvious system, method and computer program product configured to perform various advantageous features and functions including features that relate to an improved storage cabinet.

According to an exemplary embodiment, a system can include, e.g., but is not limited to: at least one storage cabinet including but not limited to: a plurality of sides; at least one front door, coupled to at least one of the plurality of the sides; at least one back door, coupled to at least one of the plurality of the sides; a plurality of forklift pockets coupled to the at least one storage cabinet; and at least one shelf coupled to the at least one storage cabinet.

According to one exemplary embodiment, the system can include where, e.g., but is not limited to: the at least one back door including but not limited to at least one or more of: at least one sliding panel; at least one lock; a metal door; a screen door; a plurality of bars; a metal frame; a metal screen; sheet metal; and/or at least one hinge.

According to one exemplary embodiment, the system can include where, e.g., but is not limited to: the plurality of forklift pockets comprise at least one or more of: wherein the plurality of forklift pockets are in a base of the at least one storage cabinet; and/or wherein the plurality of forklift pockets are at the bottom of the at least one storage cabinet.

According to one exemplary embodiment, the system can include where, e.g., but is not limited to: the plurality of sides including but not limited to at least one or more of: at least one left side wall; at least one right side wall; at least one double-walled construction; at least one metallic screen; at least one metal sheet; at least one bar; at least one metal wall; at least one metal sheet with perforations; at least one metallic mesh; and/or at least one top side wall.

According to one exemplary embodiment, the system can include where, e.g., but is not limited to: the at least one shelf including but not limited to at least one or more of: at least one rail; a plurality of rails; at least one bar; at least one metal bar; at least one metal rail of polygonal cross section; at least one metal rail of angled cross-section; and/or at least one metal rail of circular cross-section.

According to one exemplary embodiment, the system can further include e.g., but is not limited to: at least one bollard integrated into the at least one storage cabinet.

According to one exemplary embodiment, the system can further include e.g., but is not limited to: at least one or more of: a plurality of the at least one storage cabinets; at least one liquid propane gas cylinder canister stored horizontally on a plurality of rails on the at least one shelf of the at least one storage cabinet; and/or at least one forklift with a plurality of forks inserted into the plurality of forklift pockets to allow raising and lowering of the at least one storage cabinet.

According to one exemplary embodiment, the system can further include e.g., but is not limited to: at least one forklift with a plurality of forks inserted into the plurality of forklift pockets to allow raising and lowering of the at least one storage cabinet, and wherein the system of the at least one forklift and the at least one storage cabinet is configured to: place into the plurality of forklift pockets, a plurality of forklift forks of the at least one forklift; raise or lower the at least one storage cabinet; enable the at least back door to open; and enable at least one canister to be removed from the at least one shelf onto a raised platform.

According to one exemplary embodiment, the system can include where, e.g., but is not limited to: the raised platform including but not limited to at least one or more of: a flat bed of a vehicle; a flat bed of a truck; and/or a floor of a box truck.

According to one exemplary embodiment, a method of using at least one storage cabinet, where the at least one storage cabinet including but not limited to: a plurality of sides; at least one front door, coupled to at least one of the plurality of the sides; at least one back door, coupled to at least one of the plurality of the sides; a plurality of forklift pockets coupled to the storage cabinet; and at least one shelf coupled to the storage cabinet; the method including but not limited to: placing into the plurality of forklift pockets, a plurality of forklift forks by a forklift; raising or lowering the at least one storage cabinet, by the forklift; enabling opening of the at least one back door of the at least one storage cabinet; and enabling removal by sliding of at least one canister from the at least one shelf of the at least one storage cabinet onto a raised platform.

According to one exemplary embodiment, the method can include where, e.g., but is not limited to: the raised platform including but not limited to at least one or more of: a flat bed of a vehicle; a flat bed of a truck; and/or a floor of a box truck.

According to one exemplary embodiment, the system can include where, e.g., but is not limited to: the at least one storage cabinet is configured to store a canister, wherein the canister including but not limited to at least one or more of: a heavy payload; a heavy package; a heavy canister; heavy bags of ice; a liquid propane cylinder; a heavy cylinder; a heavy horizontal canister; a heavy vertical canister; a liquid propane canister; and/or wherein the at least one storage cabinet is stored outdoors.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an orthogonal front view of an exemplary canister storage cabinet with an exemplary front door, according to an exemplary embodiment of the invention;

FIG. 2 depicts an orthogonal back view of the exemplary canister storage cabinet of FIG. 1 with an exemplary back door, according to an exemplary embodiment of the invention;

FIG. 3 depicts an orthogonal left side view of the exemplary canister storage cabinet of FIG. 1 illustrating an exemplary left side edge view of the front door, and an exemplary right side edge view of the back door, according to an exemplary embodiment of the invention;

FIG. 4 depicts an orthogonal right side view of the exemplary canister storage cabinet of FIG. 1 illustrating an exemplary left side edge view of the back door, and an exemplary right side edge view of the front door, according to an exemplary embodiment of the invention;

FIG. 5 depicts an orthogonal top view of the exemplary canister storage cabinet of FIG. 1 illustrating an exemplary top edge view of the back door, and an exemplary top edge view of the front door, according to an exemplary embodiment of the invention;

FIG. 6A depicts an orthogonal top view of the exemplary canister storage cabinet of FIG. 1 illustrating a doors open top view, including an exemplary left hand side hinged exemplary top edge view of the back door, and an exemplary left hand side hinged exemplary top edge view of the front door, according to an exemplary embodiment of the invention;

FIG. 6B depicts an exemplary isometric image from an exemplary right-side view of the exemplary canister storage cabinet of FIG. 1, with front door in an acute angle of closure, and with the back door with an obtuse angle of opening, according to an exemplary embodiment of the invention;

FIG. 6C depicts an exemplary orthogonal image from a top view of the exemplary canister storage cabinet of FIG. 1, with both the front and back doors open at exemplary acute angles, exemplary two integrated bollards at an exemplary front corner, and three exemplary height alignment tabs, according to an exemplary embodiment of the invention;

FIG. 6D depicts an exemplary orthogonal front view with a closed front door and two exemplary integrated bollards, according to an exemplary embodiment of the invention;

FIG.6E depicts an exemplary orthogonal back view, with a closed back door and an exemplary four rows of exemplary height alignment tabs, according to an exemplary embodiment of the invention;

FIG. 7 depicts an exemplary figure, illustrating using the cabinet with the back door open allowing removal of canisters from the back of the cabinet, with the cabinet being lifted by a forktruck, allowing adjusting the height of the cabinet to be moved up and down, to ease sliding of empty canisters onto a truck, such as, a flatbed truck, according to an exemplary embodiment of the invention;

FIG. 8 depicts an exemplary isometric view, illustrating a first exemplary forklift pocket in a raised position of a base of the exemplary cabinet, according to an exemplary embodiment of the invention;

FIG. 9 depicts an exemplary isometric view, illustrating a second exemplary forklift pocket in a floor position of a base of the exemplary cabinet, according to an exemplary embodiment of the invention;

FIG. 10A depicts a prior art cabinet with only front door access, lacking a back door, and lacking forklift pockets;

FIG. 10B depicts a prior art crane adapted cart for removing a canister from a prior art canister storage cabinet with only front door access, lacking a back door, and lacking forklift pockets;

FIG. 10C depicts a prior art cabinet with accompanying crane cart for removing a canister from a prior art canister cabinet with only front door access, and sliding shelf, lacking a back door, and lacking forklift pockets;

FIG. 10D depicts a prior art vertical canister storage cabinet with only reinforced locking front door access, lacking a back door, and lacking forklift pockets;

FIG. 10E depicts a prior art safety storage cabinet with only reinforced walls and dual

French front doors, and lacking any back door;

FIG. 10F depicts a forklift lifting a prior art stack of stacked pallets of vertical canisters, lacking a cabinet, lacking walls, and lacking doors;

FIG. 10G depicts a prior art horizontal cylinder canister storage rack with back and side rails and a swinging front door, lacking a back door, and lacking forklift pockets;

FIG. 10H depicts a pair of prior art horizontal cylinder canister storage cabinets with only front doors, lacking a back door, and lacking forklift pockets;

FIG. 10I depicts a prior art vertical canister storage cabinet with a swinging front door, lacking a back door, and lacking forklift pockets;

FIG. 10J depicts a prior art horizontal cylinder canister storage cabinet with only front doors, lacking a back door, and lacking forklift pockets;

FIG. 10K depicts a prior art horizontal cylinder canister storage cabinet with only a single right-hinged front door, lacking a back door, and lacking forklift pockets;

FIG. 11 depicts the end view of a exemplary horizontal propane cylinder canister, as can be used on a gas-powered vehicle, such as, e.g., but not limited to, on a forklift, etc., according to an exemplary embodiment of the invention; and

FIG. 12 depicts an image of an exemplary horizontal propane cylinder canister, as can be used on a gas-powered vehicle, such as, e.g., but not limited to, on a forklift, etc., according to an exemplary embodiment of the invention.

### DETAILED DESCRIPTION OF VARIOUS EXEMPLARY EMBODIMENTS OF THE INVENTION

Various exemplary embodiments of the invention are discussed in detail below. While specific exemplary embodiments are discussed, it should be understood that this is done for illustration purposes only. Exemplary means example for purposes of this application, and various embodiments need not include all features as described herein. A person skilled in the relevant art will recognize that other components and configurations can be used without parting from the spirit and scope of the invention.

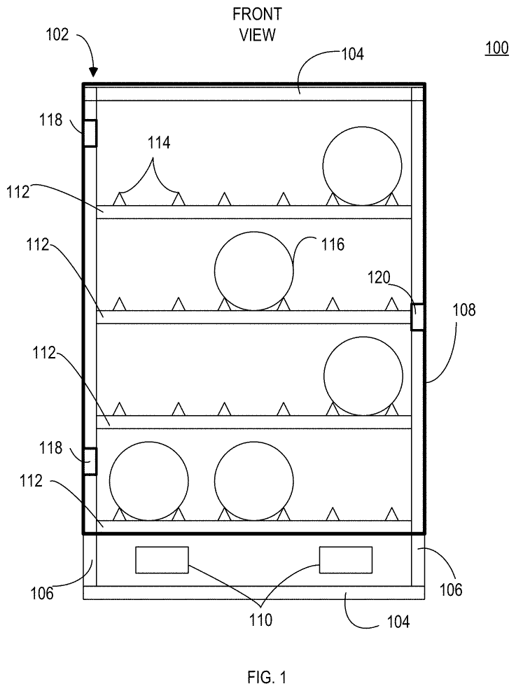

FIG. 1 depicts an orthogonal front view 100 of an exemplary canister storage cabinet 102 with an exemplary front door 108, according to an exemplary embodiment of the invention. Storage cabinet 102, according to an exemplary embodiment can include horizontal members 104, vertical members 106, according to an exemplary embodiment of the invention. Storage cabinet 102, according to an exemplary embodiment can include one or more horizontal shelves 112, one or more rails 114 to support an exemplary horizontal cylindrical canister 116, according to an exemplary embodiment of the invention. Storage cabinet 102, according to an exemplary embodiment can include one or more front doors 108, which can include one or more hinges 118, and/or one or more locking and/or handle mechanisms 120, according to an exemplary embodiment of the invention. Storage cabinet 102, according to an exemplary embodiment can include one or more forklift pockets 110, which can include reinforced envelopes to receive forks of a forklift, according to an exemplary embodiment of the invention.

According to an exemplary embodiment of front door 108, the door may be of double-walled construction or a frame with a perforated sheet, metallic mesh, screen, rod, tubular and/or sheet metal construction, according to an exemplary embodiment of the invention.

According to an exemplary embodiment forklift pockets 110 can include, a geometric cross-section, such as, e.g., but not limited to, rectangular, circular, triangular, circular, polygonal, etc., and tubular or elongated in length, enveloping an expected area of a conventional forklift fork, according to an exemplary embodiment of the invention.

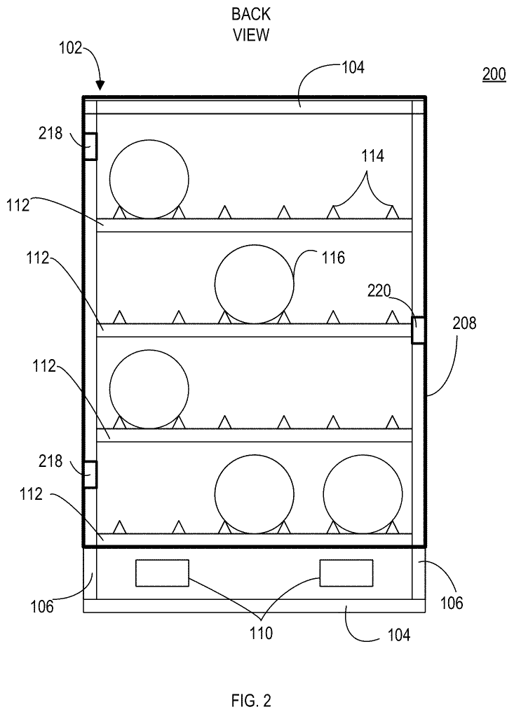

FIG. 2 depicts an orthogonal back view 200 of the exemplary canister storage cabinet 102 of FIG. 1 with an exemplary back door 208, according to an exemplary embodiment of the invention. Storage cabinet 102, according to an exemplary embodiment can include horizontal members 104, vertical members 106, according to an exemplary embodiment of the invention. Storage cabinet 102, according to an exemplary embodiment can include one or more horizontal shelves 112, one or more rails 114 to support an exemplary horizontal cylindrical canister 116, according to an exemplary embodiment of the invention. Storage cabinet 102, according to an exemplary embodiment can include one or more back doors 208, which can include one or more hinges 218, and/or one or more locking and/or handle mechanisms 220, according to an exemplary embodiment of the invention. Storage cabinet 102, according to an exemplary embodiment can include one or more forklift pockets 110, which can include reinforced envelopes to receive forks of a forklift, according to an exemplary embodiment of the invention.

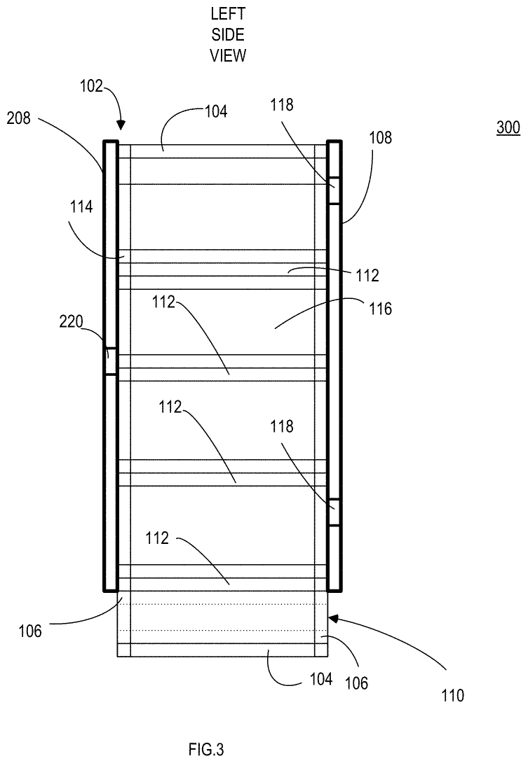

FIG. 3 depicts an orthogonal left side view 300 of the exemplary canister storage cabinet 102 of FIG. 1 illustrating an exemplary left side edge view of the front door 108, and an exemplary right side edge view of the back door 208, according to an exemplary embodiment of the invention.

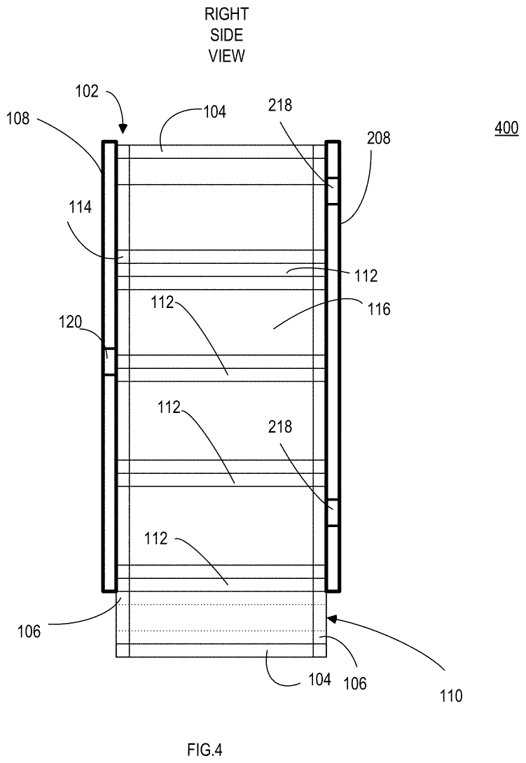

FIG. 4 depicts an orthogonal right side view 400 of the exemplary canister storage cabinet 102 of FIG. 1 illustrating an exemplary left side edge view of the back door 208, and an exemplary right side edge view of the front door 108, according to an exemplary embodiment of the invention.

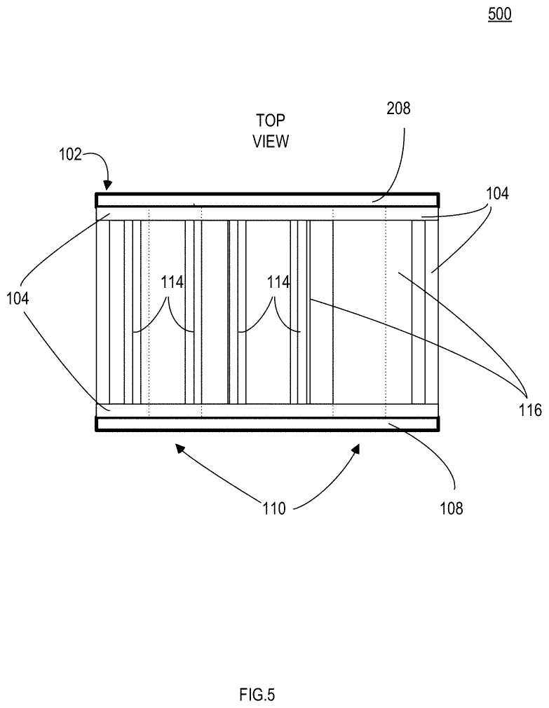

FIG. 5 depicts depicts an orthogonal top view 500 of the exemplary canister storage cabinet of FIG. 1 102 illustrating an exemplary top edge view of the back door 208, and an exemplary top edge view of the front door 108, and showing several rails 114, which can include in an exemplary embodiment a piece of metal fold at an angle, or a metallic bar or polygonal cross-sectioned bar, according to an exemplary embodiment of the invention.

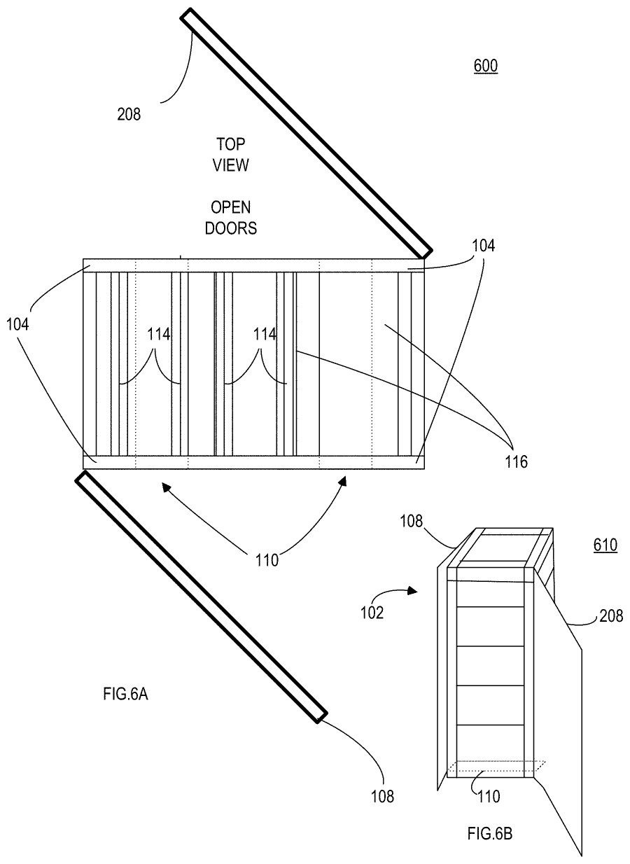

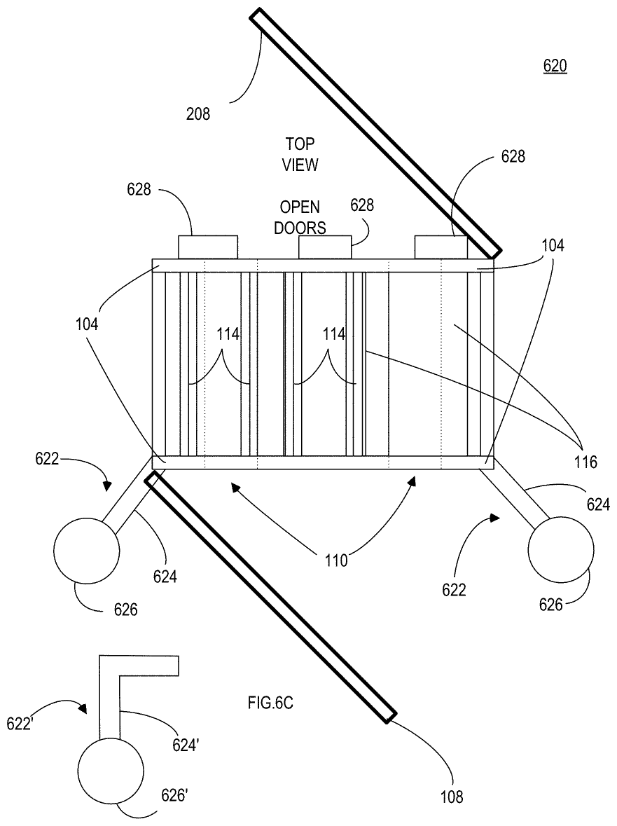

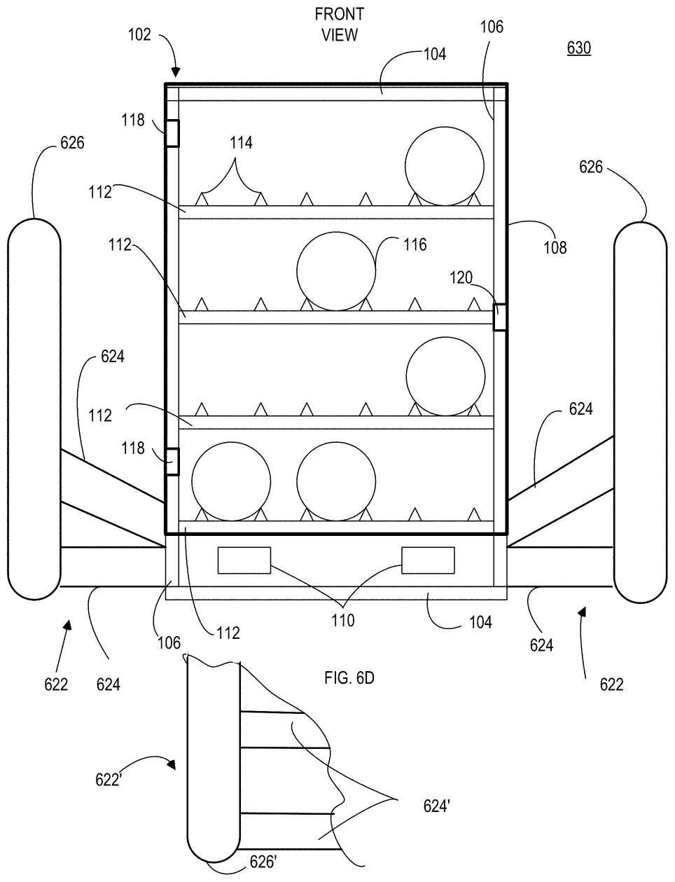

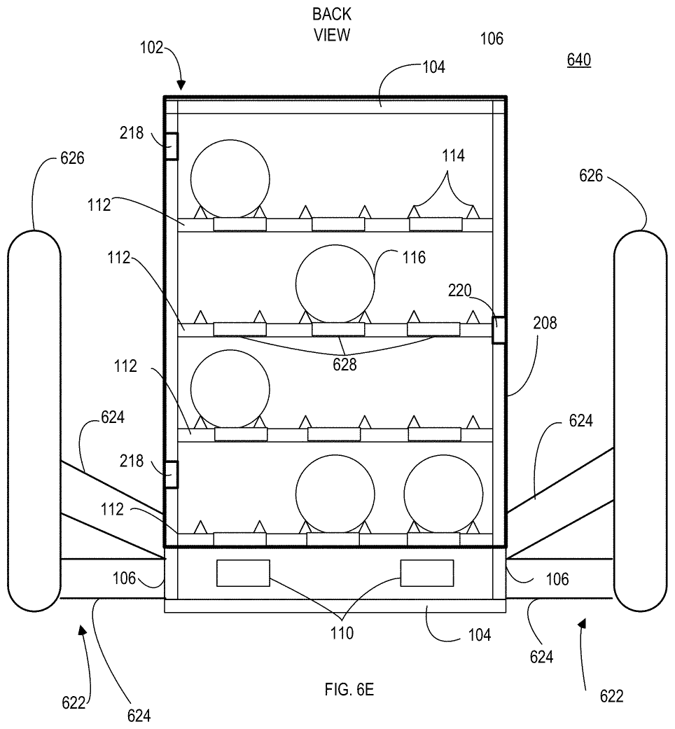

FIG. 6A depicts an orthogonal top view 600 of the exemplary canister storage cabinet 102 of FIG. 1 illustrating doors 108, 208 in an open position top view, including an exemplary left hand side hinged exemplary top edge view of the back door 208 , and an exemplary left hand side hinged exemplary top edge view of the front door 108, as well as an exemplary isometric image 610 from an exemplary right side view with front door 108 in an acute angle of closure, and with back door 208 with an obtuse angle of opening, according to an exemplary embodiment of the invention.

FIG. 6B depicts an exemplary isometric image from an exemplary right-side view 610 of the exemplary canister storage cabinet 102 of FIG. 1, with front door 108 in an acute angle of closure, and with the back door 208 with an obtuse angle of opening, according to an exemplary embodiment of the invention.

FIG. 6C depicts an exemplary orthogonal view 620 from a top view of the exemplary canister storage cabinet 102 of FIG. 1, with both the front 108 and back 208 doors open at exemplary acute angles, exemplary two integrated bollards 622, including, for example, exemplary connectors 624 and metal columns 626, located at the front corners creating exemplary, but not required, obtuse angles with front horizontal member 104, and three exemplary height alignment tabs 628, which can be used to align the canister storage cabinet row by row vertically on the back of a pickup truck bed, according to an exemplary embodiment of the invention. Exemplary alignment tabs 628 can include one or more tabs per row, per shelf, for aligning the height of an exemplary shelf 112 with the height of a truck bed (not shown), according to an exemplary embodiment of the invention. According to one exemplary embodiment, doors 208, and/or 108 can be removable easing access to the cabinet and use of height alignment tabs 628, according to an exemplary embodiment of the invention. An exemplary alternative top view of the exemplary integrated bollard coupled to the canister storage cabinet 102 is shown with alternative bollard 622′, with exemplary vertical portion 626′ and alternative right angled top view coupler 624′ including one or more vertical, horizontal or angled members, according to an exemplary embodiment of the invention.

FIG. 6D depicts an exemplary orthogonal front view 630 of the exemplary canister storage cabinet 102 of FIG. 1, with closed front door 108 and two exemplary integrated bollards 622, according to an exemplary embodiment of the invention. An exemplary alternative front view of the exemplary integrated bollard coupled to the canister storage cabinet 102 is shown with alternative bollard 622′, with exemplary vertical portion 626′ and alternative front view coupler 624′ including one or more vertical, horizontal or angled members, according to an exemplary embodiment of the invention.

FIG. 6E depicts an exemplary orthogonal back view 640, with a closed back door 208 and an exemplary four rows of exemplary height alignment tabs 628, according to an exemplary embodiment of the invention.

According to an exemplary embodiment of the invention, doors 108, 208 each can instead be replaced by two or more doors such as, e.g., but not limited to, French doors, etc.,

FIG. 7 depicts an exemplary FIG. 700, illustrating using the cabinet 102 with the back door 208 open allowing removal of canisters from the back of the cabinet, with the cabinet being lifted by a forklift 702, allowing adjusting the height of the cabinet 102 to be moved up and down 706 relative to a truck 704, to ease sliding of empty canisters onto the truck 704, such as, e.g., but not limited to, a flatbed truck, etc., for refilling, according to an exemplary embodiment of the invention.

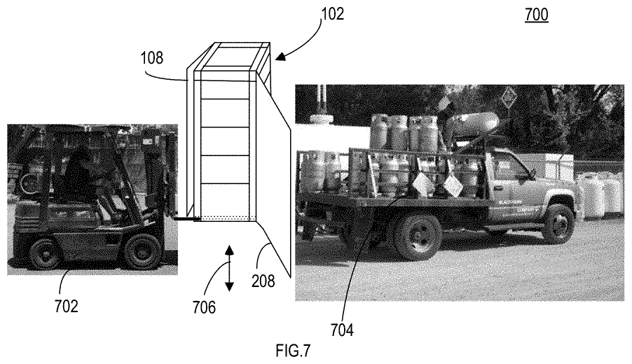

FIG. 8 depicts an exemplary isometric view 800, illustrating a first exemplary forklift pocket 110 in a raised position as shown in FIG. 1 above a base of the exemplary cabinet 102, according to an exemplary embodiment of the invention.

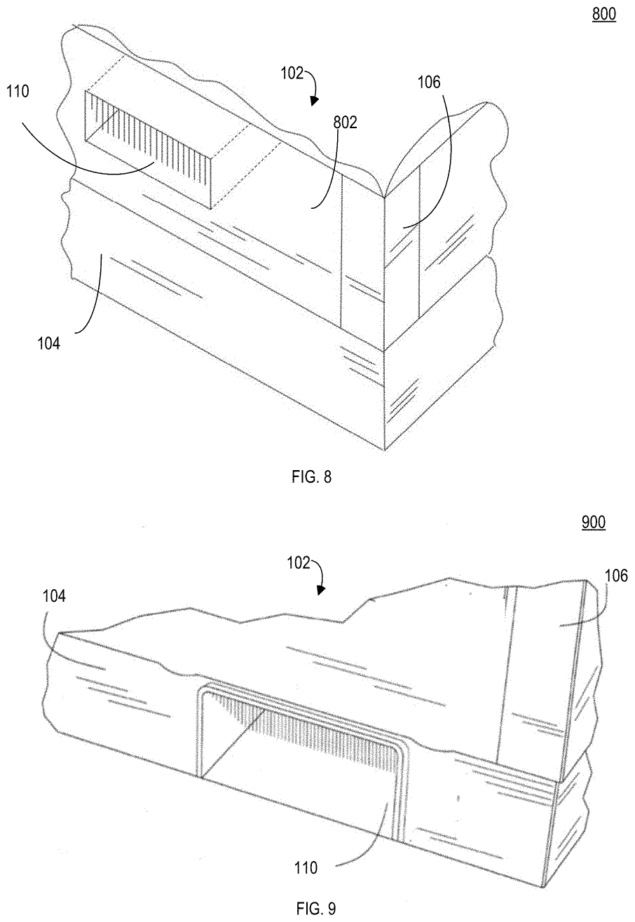

FIG. 9 depicts an exemplary isometric view 900, illustrating a second exemplary forklift pocket 110 in a floor position of a base of the exemplary cabinet 102, according to an exemplary embodiment of the invention.

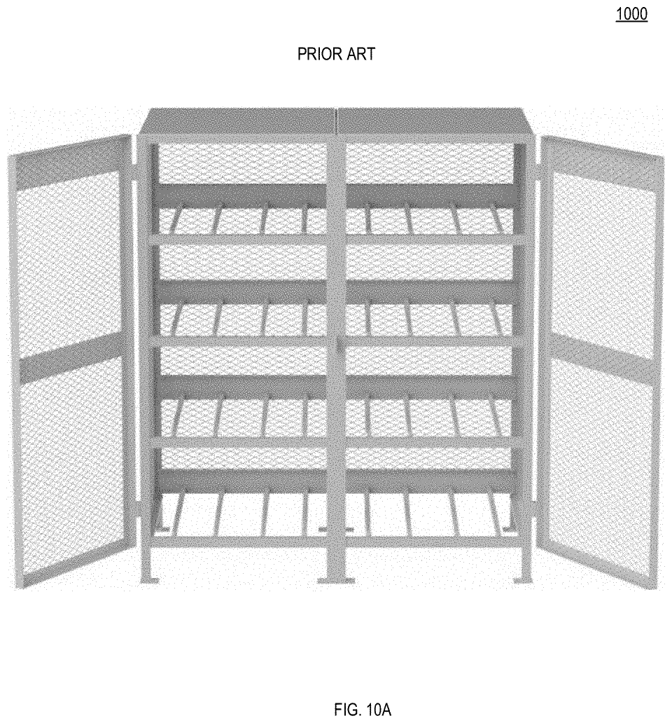

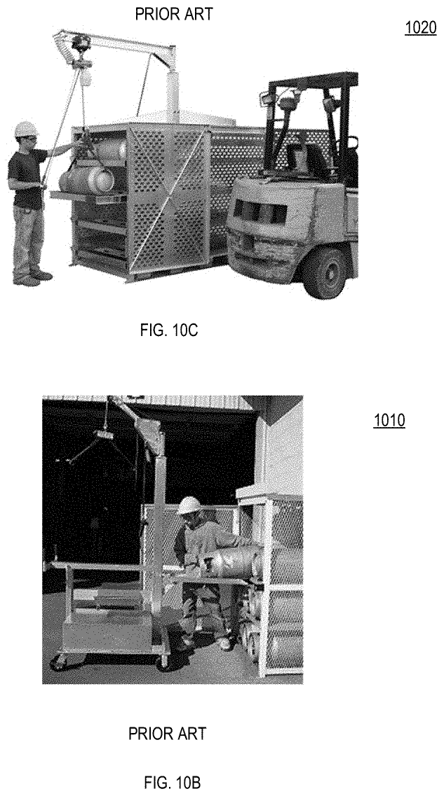

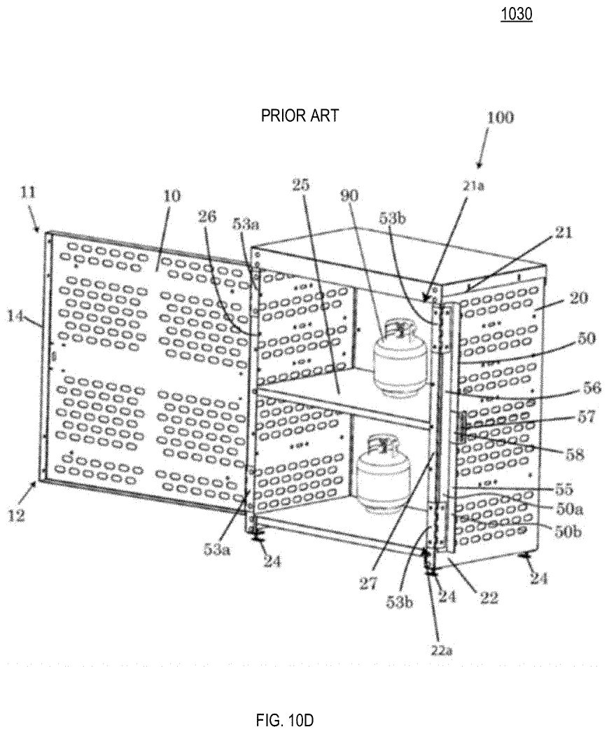

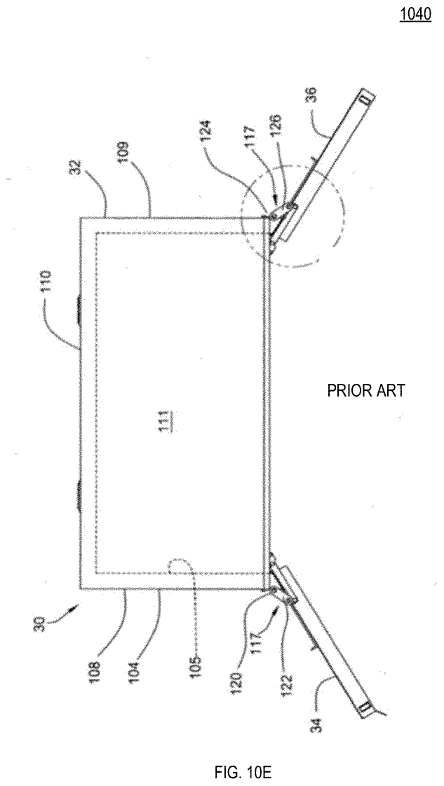

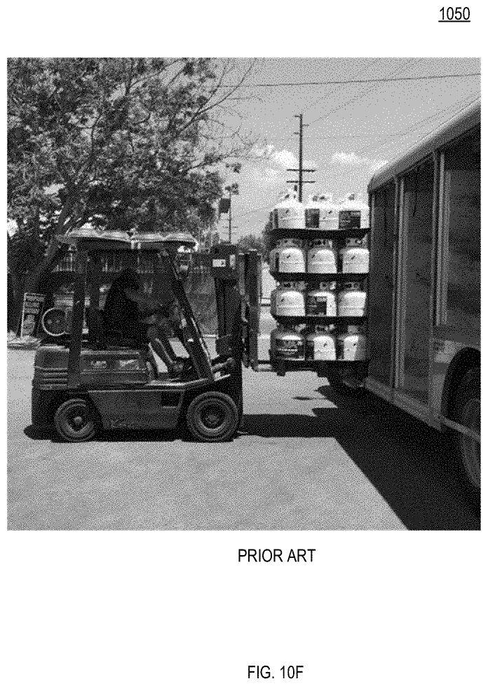

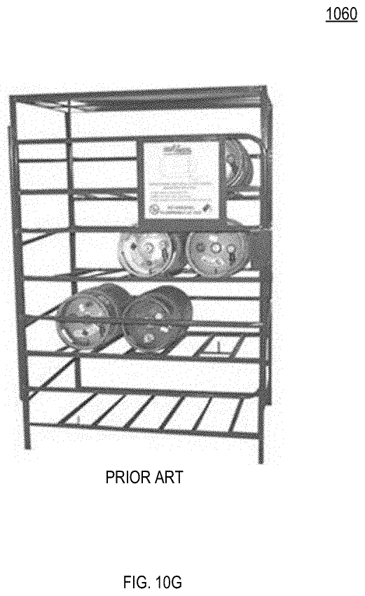

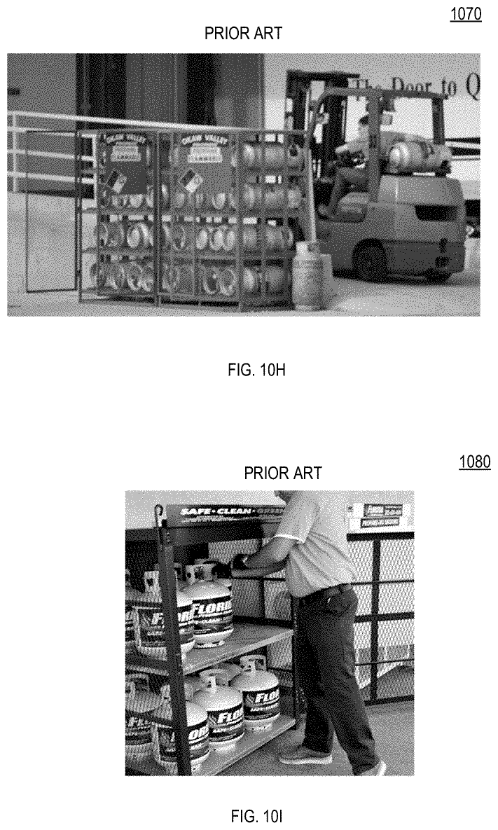

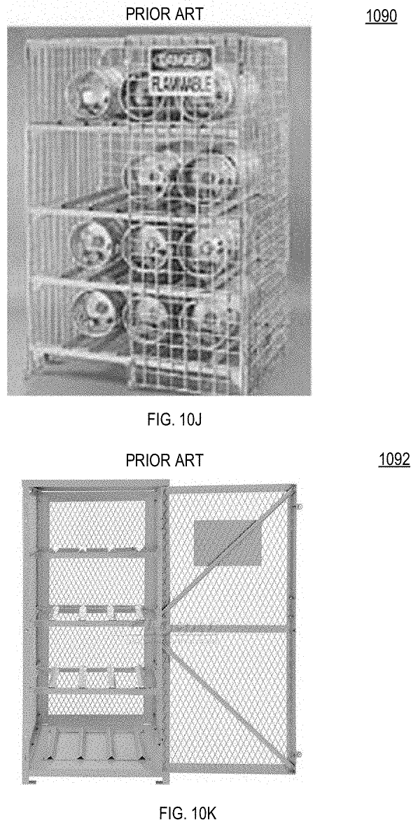

FIG. 10A depicts an image 1000 of a prior art cabinet with only front door access, lacking a back door, and lacking forklift pockets. In certain exemplary embodiments of the invention, features from conventional cabinets may be included.

FIG. 10B depicts an image 1010 of a prior art crane adapted cart for removing a canister from a prior art canister storage cabinet with only front door access, lacking a back door, and lacking forklift pockets. In certain exemplary embodiments of the invention, features from conventional cabinets may be included.

FIG. 10C depicts an image 1020 of a prior art cabinet with accompanying crane for removing a canister from a prior art canister cabinet with only front door access, and sliding shelf, lacking a back door, and lacking forklift pockets. In certain exemplary embodiments of the invention, features from conventional cabinets may be included.

FIG. 10D depicts an image 1030 of a prior art vertical canister storage cabinet with only reinforced locking front door access, lacking a back door, and lacking forklift pockets.

FIG. 10E depicts an image 1040 of a prior art safety storage cabinet with only reinforced walls and dual French front doors and lacking any back door. In certain exemplary embodiments of the invention, features from conventional cabinets may be included.

FIG. 10F depicts an image 1050 of a forklift lifting a prior art stack of stacked pallets of vertical canisters, lacking a cabinet, lacking walls, and lacking doors. In certain exemplary embodiments of the invention, features from conventional cabinets may be included.

FIG. 10G depicts an image 1060 of a prior art horizontal cylinder canister storage rack with back and side rails and a swinging front door, lacking a back door, and lacking forklift pockets. In certain exemplary embodiments of the invention, features from conventional cabinets may be included.

FIG. 10H depicts an image 1070 of a pair of prior art horizontal cylinder canister storage cabinets with only front doors, lacking a back door, and lacking forklift pockets. In certain exemplary embodiments of the invention, features from conventional cabinets may be included.

FIG. 10I depicts an image 1080 of a prior art vertical canister storage cabinet with a swinging front door, lacking a back door, and lacking forklift pockets. In certain exemplary embodiments of the invention, features from conventional cabinets may be included.

FIG. 10J depicts an image 1090 of a prior art horizontal cylinder canister storage cabinet with only front doors, lacking a back door, and lacking forklift pockets. In certain exemplary embodiments of the invention, features from conventional cabinets may be included.

FIG. 10K depicts an image 1092 of a prior art horizontal cylinder canister storage cabinet with only a single right-hinged front door, lacking a back door, and lacking forklift pockets. In certain exemplary embodiments of the invention, features from conventional cabinets may be included.

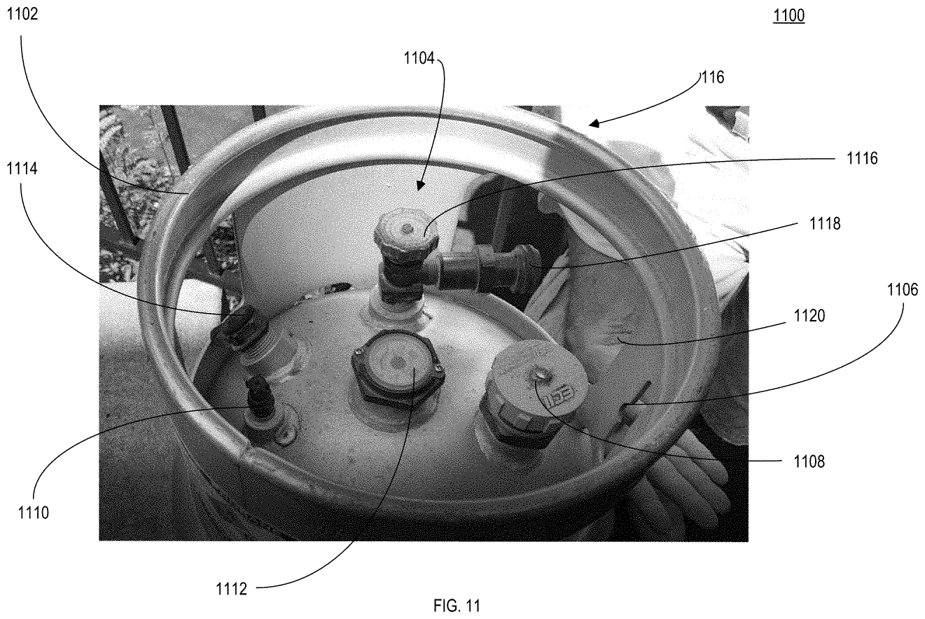

FIG. 11 depicts the end image 1100 of a exemplary horizontal propane cylinder canister 116, as can be used on a gas powered vehicle, such as, e.g., but not limited to, on a forklift, etc., according to an exemplary embodiment of the invention.

According to an exemplary embodiment of the invention, canister 116 can include a metal collar 1102 to protect valve stems, 1104 the liquid withdrawal system 1104, which can include a turning service valve 1116, a one-way adaptor 1118, and an opening 1120 to connect or couple the forklift hose (not shown) to the canister 116, a small opening 1106 to connect or couple the metallic cylinder to the forklift in the correct orientation, a fill valve 1108, used to fill the cylinder with liquid propane, a dip tube 1110 indicating a filled cylinder when in vertical orientation for filling, a float gauge 1112 indicating the amount of propane when the canister is in a horizontal orientation with hole 1106 downward, and a vapor vent 1114, used to release pressure of canister when needed. These canisters are normally used in a horizontal position for liquid carburetion applications, e.g., forklifts, etc., which provide greater power than in vapor applications use in consumer grills, etc.

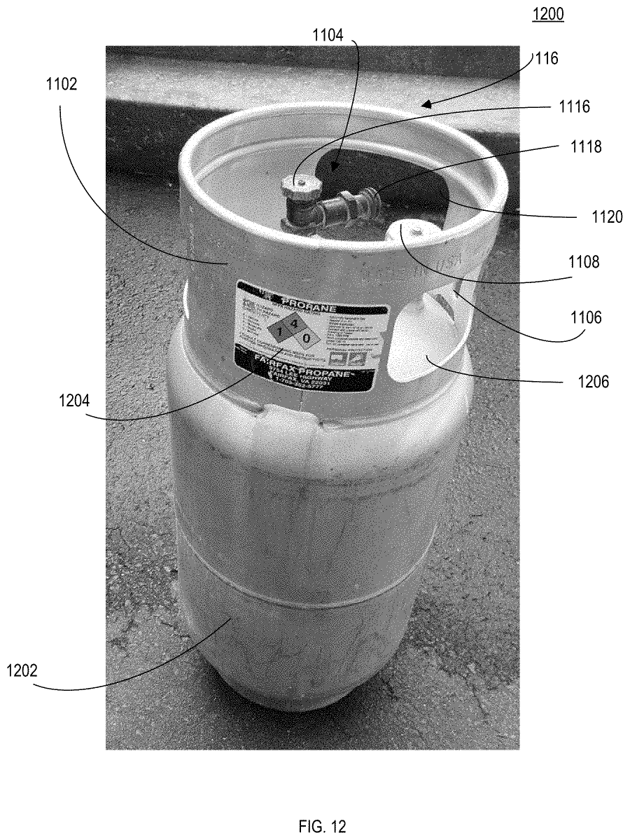

According to one exemplary embodiment, an exemplary improved cylinder comprises a plurality of fixed liquid level gauges, or so-called dip tubes 1110, which can be included to allow determining when a correct fill level of the cylinder or canister is reached, in either of a horizontal or a vertical orientation, according to an exemplary embodiment. Conventional forklift LP gas cylinders must be filled only in a vertical orientation, so as to correctly determine when the forklift LP gas cylinder, as shown in FIGS. 11 and 12, is filled, by observing liquid sputtering from the dip tube 1110. Advantageously, according to an exemplary embodiment, an improved tank can include 2 dip tubes 1110, one dip tube to indicate a full tank when 80% filled when the cylinder is in a vertical orientation as is conventional, and a second dip tube to indicate when a tank is 80% full when filled in a horizontal orientation. The novel second dip tube is oriented to be placed in such orientation within the tank so that when the tank is placed in a predefined horizontal position for filling, such as, e.g., but not limited to, with the horizontal orientation with hole 1106 downward, that when the tank has been filled to a desired filled state, i.e., 80% full to allow for safe expansion and contraction based on anticipated temperature variability. The internal end of the second dip tube can be placed at a proper height to only detect the fill level when in correct orientation, and can be shielded to avoid inaccurate indication of filling from splash during filling of the tank through the fill valve 1108.

FIG. 12 depicts a side image 1200 of an exemplary horizontal propane cylinder canister 116, as can be used on a gas-powered vehicle, such as, e.g., but not limited to, on a forklift, etc., according to an exemplary embodiment of the invention.

According to an exemplary embodiment of the invention, canister 116 can include, payload storage 1202, a safety label 1204, and a metal collar 1102 to protect valve stems, 1104 the liquid withdrawal system 1104, which can include a turning service valve 1116, a one-way adaptor 1118, and an opening 1120 to connect or couple the forklift hose (not shown) to the canister 116, other holes 1206, a small opening 1106 to connect or couple the metallic cylinder to the forklift in the correct orientation, a fill valve 1108, used to fill the cylinder with liquid propane, a spit-valve 1110 (not shown in this image) indicating a filled cylinder when in vertical orientation for filling, a float gauge 1112 (not shown in this image) indicating the amount of propane when the canister is in a horizontal orientation with hole 1106 downward, and a vapor vent 1114 (not shown in this image), used to release pressure of canister when needed. These canisters are normally used in a horizontal position for liquid carburetion applications, e.g., forklifts, etc., which provide greater power than in vapor applications use in consumer grills, etc.

While various specific example embodiments have been illustrated and described herein to assist a person having ordinary skill in the relevant art to allow making and using the claimed inventions, numerous modifications come to mind without significantly departing from the spirit of the invention, and the scope of breadth of protection is only limited by the scope of the accompanying claims and their equivalents as set forth below.

1. A system comprising:
at least one storage cabinet comprising:
a plurality of sides;
at least one front door, coupled to at least one of said plurality of said sides;
at least one back door, coupled to at least one of said plurality of said sides;
at least one forklift pocket coupled to said at least one storage cabinet; and
at least one shelf coupled to said at least one storage cabinet.

2. The system according to claim 1, wherein said at least one back door comprises at least one or more of:
at least one sliding panel;
at least one lock;
a metal door;
a screen door;
a plurality of bars;
a metal frame;
a metal screen;
sheet metal; or
at least one hinge.

3. The system according to claim 1, wherein said at least one forklift pocket comprises at least one or more of:
wherein said at least one forklift pocket is in a base of said at least one storage cabinet; or
wherein said at least one forklift pocket is at the bottom of said at least one storage cabinet.

4. The system according to claim 1, wherein said plurality of sides comprises at least one or more of:
at least one left side wall;
at least one right side wall;
at least one double-walled construction;
at least one metallic screen;
at least one metal sheet;
at least one bar;
at least one metal wall;
at least one metal sheet with perforations;
at least one metallic mesh; or
at least one top side wall.

5. The system according to claim 1, wherein said at least one shelf comprises at least one or more of:
at least one rail;
a plurality of rails;
at least one bar;
at least one metal bar;
at least one metal rail of polygonal cross section;
at least one metal rail of angled cross-section; or
at least one metal rail of circular cross-section.

6. The system according to claim 1, further comprising:
at least one bollard integrated into said at least one storage cabinet.

7. The system according to claim 6, wherein said at least one bollard comprises at least one or more of:
a vertical metal bollard;
a vertical bollard;
a vertical cylindrical bollard;
a vertical rectangular bollard;
a rounded bollard; or
a coupler member coupling said at least one bollard to said at least one bollard to said at least one storage cabinet.

8. The system according to claim 1, further comprising at least one or more of:
a plurality of said at least one storage cabinets;
at least one liquid propane gas cylinder canister stored horizontally on a plurality of rails on said at least one shelf of said at least one storage cabinet; or
at least one forklift with a plurality of forks inserted into said plurality of forklift pockets to allow raising and lowering of said at least one storage cabinet.

9. The system according to claim 1, further comprising at least one forklift with a plurality of forks inserted into said plurality of forklift pockets to allow raising and lowering of said at least one storage cabinet, and
wherein the system of said at least one forklift and said at least one storage cabinet is configured to:
place into said plurality of forklift pockets, a plurality of forklift forks of said at least one forklift;
raise or lower said at least one storage cabinet;
enable said at least back door to open; and
enable at least one canister to be removed from said at least one shelf onto a raised platform.

10. The system according to claim 9, wherein the raised platform comprises at least one or more of:
a flat bed of a vehicle;
a flat bed of a truck; or
a floor of a box truck.

11. The system according to claim 9, wherein
wherein said at least one storage cabinet is configured to store a canister, wherein said canister comprises at least one or more of:
a heavy payload;
a heavy package;
a heavy canister;
heavy bags of ice;
a liquid propane cylinder;
a heavy cylinder;
a heavy horizontal canister;
a heavy vertical canister;
a liquid propane canister; or
wherein said at least one storage cabinet is stored outdoors.

12. The system according to claim 1, further comprising:
at least one height alignment tab.

13. (Withdrawn and Currently Amended) A method of using at least one storage cabinet,
wherein the at least one storage cabinet comprises:
a plurality of sides;
at least one front door, coupled to at least one of the plurality of said sides;
at least one back door, coupled to at least one of the plurality of said sides;
at least one forklift pocket coupled to the storage cabinet; and
at least one shelf coupled to the storage cabinet;
the method comprising:
placing into the at least one forklift pocket, at least one forklift fork by a forklift;
raising or lowering the at least one storage cabinet, by the forklift;
enabling opening of the at least one back door of the at least one storage cabinet; and
enabling removal by sliding of at least one canister from the at least one shelf of the at least one storage cabinet onto a raised platform.

14. The method according to claim 13, wherein the raised platform comprises at least one or more of:
a flat bed of a vehicle;
a flat bed of a truck; or
a floor of a box truck.

15. The method according to claim 13, further comprising:
at least one height alignment tab.
